(19) United States
(12) Patent Application Publication
(10) Pub. No.: US 2002/0100322 A1
(43) Pub. Date: Aug. 1, 2002

(54) Vibrating gyroscope and temperature-drift adjusting method therefor

(75) Inventors: Kazuhiro Ebara, Shiga-ken (JP); Tsuguji Kambayashi, Toyama-ken (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/040,834

(22) Filed: Jan. 7, 2002

(30) Foreign Application Priority Data
Jan. 31, 2001 (JP) 2001-023589

(51) Int. Cl. G01P 21/00

(52) U.S. Cl. 73/497; 73/504.12; 73/1.38

(57) ABSTRACT

A vibrating gyroscope includes a vibrator and an oscillation circuit for exciting the vibrator. Detecting terminals of the vibrator are connected to ground through load resistances, and are also connected to a differential circuit. A synchronous detection circuit detects a signal output from the differential circuit. A smoothing circuit smoothes a signal output from the synchronous detection circuit. An amplifying circuit amplifies a signal output from the smoothing circuit. Resistance values of the load resistances are adjusted depending on temperature drift gradient of the vibrating gyroscope, such that the temperature drift gradient is minimized.

### BACKGROUND OF THE INVENTION

1. Field of the Invention

This invention relates to a vibrating gyroscope and a temperature-drift adjusting method therefor. More specifically, the present invention relates to a vibrating gyroscope and a temperature-drift adjusting method therefor which are applicable to, for example, a system for detecting the behavior of a mobile unit by detecting the rotation angular velocity, a navigation system for adequately guiding a mobile unit by detecting the location thereof, and a vibration control system including a device for damping vibrations by detecting the rotation angular velocity due to external vibrations such as hand shaking.

2. Description of the Related Art

FIG. 10 is a schematic diagram illustrating an example of a vibrating gyroscope of the related art. A vibrating gyroscope 1 includes a vibrator 2. The vibrator 2 includes a vibration member 3 in the form of, for example, a regular triangular prism. Piezoelectric elements 4a, 4b, and 4c are formed on the three side surfaces of the vibration member 3, respectively. These piezoelectric elements 4a, 4b, and 4c each include a piezoelectric layer made of ceramic or the like. Both surfaces of each piezoelectric layer of the piezoelectric elements 4a, 4b, and 4c are provided with electrodes, one of which is bonded to the side surface of the vibration member 3.

An oscillation circuit 5 is connected between the pair of piezoelectric elements 4a and 4b, and the piezoelectric element 4c. A signal output from the piezoelectric element 4c is fed back to the oscillation circuit 5, where the phase of the signal is corrected. The resulting signal serving as a drive signal is then supplied to the piezoelectric elements 4a and 4b. This drive signal causes the vibration member 3 to bend and vibrate in the direction perpendicular to the surface on which the piezoelectric element 4c is formed.

The two piezoelectric elements 4a and 4b are connected to a signal processing circuit. The signal processing circuit includes a differential circuit 6, a synchronous detection circuit 7, a smoothing circuit 8, and an amplifying circuit 9. The piezoelectric element 4a and 4b are connected to input ports of the differential circuit 6. An output port of the differential circuit 6 is connected to the synchronous detection circuit 7. The synchronous detection circuit 7 synchronizes with a signal from the oscillation circuit 5 to detect a signal output from the differential circuit 6. The synchronous detection circuit 7 is connected to the smoothing circuit 8, which is in turn connected to the amplifying circuit 9.

In this vibrating gyroscope 1, the oscillation circuit 5 causes the vibration member 3 to bend and vibrate in the direction perpendicular to the surface on which the piezoelectric element 4c is formed. When the vibration member 3 is not rotated, the output signals from the piezoelectric elements 4a and 4b are the same, so that no signals of the piezoelectric elements 4a and 4b are output from the differential circuit 6. However, when the vibration member 3 is rotated about the axis thereof, the vibration direction of the vibration member 3 changes due to the Coriolis force. Consequently, a difference is generated between the output signals of the piezoelectric elements 4a and 4b, thereby causing the differential circuit 6 to output a signal. The output signal from the differential circuit 6 is detected by the synchronous detection circuit 7, smoothed by the smoothing circuit 8, and then amplified by the amplifying circuit 9. Since the output signal from the differential circuit 6 corresponds to a change in the vibration direction of the vibration member 3, a rotation angular velocity applied to the vibrator 2 can be detected by measuring the signal output from the amplifying circuit 9.

The vibrating gyroscope 1 is formed so as to output a signal that serves as a reference voltage at about 25° C. when not rotating; however, the output signals from the vibrator 2 and the signal processing circuit exhibit temperature drift, and thus vary depending upon the ambient temperature. One possible method for suppressing such temperature drift is to configure the circuit so that the null voltage (a drift component) is not generated. Another method is, as discussed in Japanese Unexamined Patent Application Publication No. 7-091957, to negate a generated null voltage (a temperature drift component) by adding and subtracting a signal-processed voltage of the null voltage to and from the generated null voltage. Still another method is, as shown in Japanese Unexamined Patent Application Publication No. 2000-171258, to negate temperature drift components of a vibrating gyroscope by generating a temperature-dependent gain in a signal processing.

In the circuit disclosed in Japanese Unexamined Patent Application Publication No. 7-091957, as shown in FIG. 11, signals output from two piezoelectric elements 4a and 4b of a vibrator 2 are input to a differential amplifying circuit 6, and output signals from the differential amplifying circuit 6 are input to synchronous detection circuits 7a and 7b. The synchronous detection circuit 7a detects the signal output from the differential amplifying circuit 6, as with the vibrating gyroscope shown in FIG. 10, while the other synchronous detection circuit 7b detects the signal output from the differential amplifying circuit 6 by synchronizing with a signal 90° out of phase with a synchronization signal for the synchronous detection circuit 7a. Thus, the synchronous detection circuit 7a outputs the amplitude difference of the drift components, while the other synchronous detection circuit 7b outputs the phase difference of the drift components. By removing the difference between these drift components, the null voltage is negated. In addition, a temperature compensation circuit is provided so that the drift components become substantially uniform.

The vibrating gyroscope disclosed in Japanese Unexamined Patent Application Publication No. 2000-171258 is configured to have, as shown in FIG. 12, a gain-temperature characteristic that exhibits temperature drift opposite to the temperature drift of the vibrator in the circuit as shown in FIG. 10. The vibrating gyroscope is also configured to have an offset adjustment capability. Consequently, as shown in FIG. 13, signals having almost uniform offset voltages are output regardless of the change in temperature. In addition, a second offset adjustment circuit is used to allow adjustment of an output, when not rotating, to a desired value such as a reference voltage, Vdd/2, or the like.

Nevertheless, if the circuit is configured such that the null voltage of the vibrator is not generated, due to complicated factors for the generation of the null voltage, the configuration of the circuit for negating or canceling the null voltage will also become very complicated. The vibrating gyroscope as shown in FIG. 11 requires many circuits to be attached thereto. These circuits also generate temperature drift components, thus making it difficult to suppress the temperature drift components of the entire vibrating gyroscope. In addition, while a vibrating gyroscope including a processing circuit having a temperature-dependent gain has a relatively simple circuit configuration, it requires the offset adjustment a second time, thus necessitating two offset adjusting circuits. This is because the offset adjustment is performed such that, with the offset voltage being held substantially constant, the offset voltage is shifted so as to minimize the temperature drift. Such a vibrating gyroscope, therefore, requires a complicated adjustment process, which is not preferable.

### SUMMARY OF THE INVENTION

Accordingly, it is an object of the present invention to provide a vibrating gyroscope having a simple circuit configuration and a small temperature drift at low cost.

Another object of the present invention is to provide a temperature-drift adjusting method for allowing the provision of such a vibrating gyroscope.

To these ends, according to one aspect of the present invention, there is provided a temperature-drift adjusting method of a vibrating gyroscope which includes a vibrator having a detecting terminal for extracting electric charge that is generated due to a Coriolis force; an oscillation circuit for vibrating the vibrator; a load impedance, connected to the detecting terminal of the vibrator, for converting the electric charge into a voltage; and a signal processing circuit for processing a signal output from the detecting terminal of the vibrator and for outputting a signal corresponding to a rotation angular velocity. The method includes adjusting the value of the load impedance in accordance with a temperature drift gradient indicating a change in a voltage output from the signal processing circuit in response to a change in temperature to minimize the temperature drift gradient.

Preferably, the vibrator comprises at least two of the detecting terminals and at least two of the load impedances are connected to the corresponding detecting terminals. The impedance values of the load impedances are then adjusted.

According to another aspect of the present invention, there is provided a vibrating gyroscope wherein the temperature drift of the vibrating gyroscope is adjusted by the temperature-drift adjusting method mentioned the above.

Temperature drift is generated in accordance with the value of the impedance of the detecting terminal of the vibrator where electrical charge is generated due to the Coriolis force. In this case, the temperature drift can be adjusted by adjusting the value of the load impedance connected to the detecting terminal of the vibrator.

In the case of the vibrator having two detecting terminals, the load impedances are connected to the two detecting terminals, and the temperature drift can be adjusted by adjusting the relationship between the two load impedances.

By employing these methods, the temperate drift can be adjusted with a simple circuit, which can provide a low-cost vibrating gyroscope.

These and other objects, features, and advantages of the present invention will become more apparent from the following embodiment of the present invention with reference to the appended drawings.

### BRIEF DESCRIPTION OF THE DRAWING(S)

FIG. 1 is a schematic diagram of a vibrating gyroscope according to an embodiment of the present invention;

FIG. 2 is a perspective view of one example of a vibrator for use in the vibrating gyroscope of the present invention;

FIG. 3 is a perspective view of another example of the vibrator for use in the vibrating gyroscope of the present invention;

FIG. 4 is a graph showing the temperature drift gradient of the vibrating gyroscope;

FIG. 5 is a graph showing the temperature drift gradient for load resistances having the same resistance values in the case where the impedances of detecting terminals of a vibrator are the same;

FIG. 6 is an equivalent circuit diagram showing the relationship between the impedances of the detecting terminals of the vibrator and load resistances;

FIG. 7 is a graph showing the temperature drift gradient for the load resistances having different resistance values from each other in the case where the impedances of the detecting terminals of the vibrator are different from each other;

FIG. 8 is an equivalent circuit diagram of the impedances of the detecting terminals of the vibrator;

FIG. 9 is a schematic diagram of a vibrating gyroscope according to another embodiment of the present invention;

FIG. 10 is a schematic diagram of an example of a vibrating gyroscope of the related art;

FIG. 11 is a schematic diagram of another example of a vibrating gyroscope of the related art;

FIG. 12 is a graph showing the temperature drift of the vibrator and the temperature characteristic of a signal processing circuit in the case where the signal processing circuit in the vibrating gyroscope shown in FIG. 10 has a temperature-dependent gain;

FIG. 13 is a graph showing a voltage output from the vibrating gyroscope having the characteristic shown in FIG. 12; and

FIG. 14 is a schematic diagram showing another example of a vibrating gyroscope of the related art.

### DETAILED DESCRIPTION OF EMBODIMENTS OF THE INVENTION

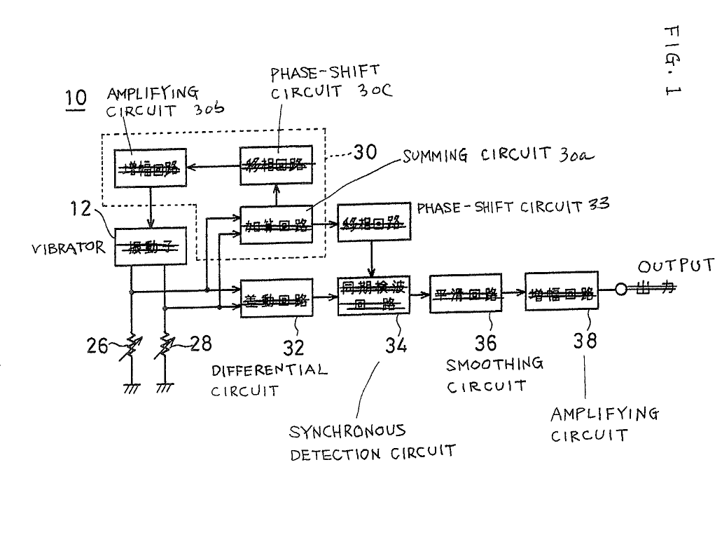

A vibrating gyroscope according to one embodiment of the present invention is illustrated in the schematic diagram of FIG. 1. A vibrating gyroscope 10 includes a vibrator 12 that may be of the bimorph type shown in FIG. 2. The vibrator 12 includes a vibration member 18. The vibration member 18 has two plate-like piezoelectric members 14 and 16 laminated with each other. The piezoelectric members 14 and 16 are polarized in opposite directions to each other, as indicated by the arrows in FIG. 2. Two electrodes 20a and 20b which are separated in the width direction are formed on the piezoelectric member 14, and are used as detecting terminals for outputting signals corresponding to the Coriolis force. An excitation electrode 22 is also formed on an entire surface of the piezoelectric member 16 and is used as an excitation terminal for bending and vibrating the vibration member 18.

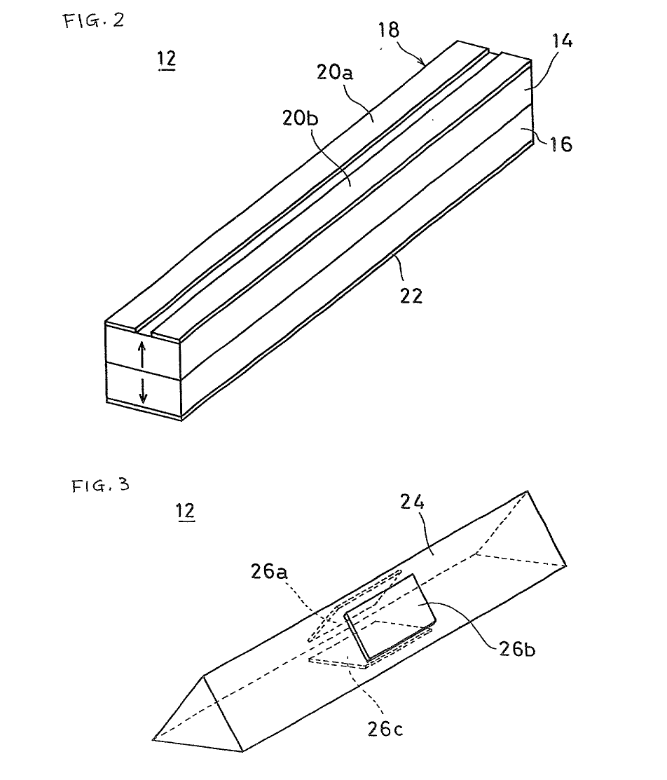

As shown in FIG. 3, a vibrator 12 having a vibration member 24 in the form of a regular triangular prism may also be used. The vibration member 24 is typically formed of a material that generates mechanical vibrations, such as elinvar, an iron-nickel alloy, quartz, glass, crystal, or ceramic.

Piezoelectric elements 26a, 26b, and 26c are formed on the three side surfaces of the vibration member 24, respectively. The piezoelectric elements 26a, 26b, and 26c each include a piezoelectric layer made of ceramic or the like. Both surfaces of each piezoelectric layer of the piezoelectric elements 26a, 26b, and 26c are provided with electrodes, one of which is bonded to the side surface of the vibration member 24. Two piezoelectric elements 26a and 26b are used as detecting member or terminals for outputting signals corresponding to the Coriolis force, while the other piezoelectric element 26c is used as an excitation member or terminal for vibrating the vibration member 24 in a bending mode vibration.

As shown in FIG. 1, the detecting terminals of the vibrator 12 are connected as load impedances to ground through load resistances 26 and 28, respectively. The load resistances 26 and 28 are used not only to convert an electric charge generated due to the vibration of the vibrator 12 into a voltage, but are also used to adjust the temperature drift. Thus, variable resistances or the like may be used for the load resistances 26 and 28.

The detecting terminals of the vibrator 12 are also connected to input ports of an oscillation circuit 30. The oscillation circuit 30 includes a summing circuit 30a, an amplifying circuit 30b, and a phase-shift circuit 30c, so that output signals from the two detecting terminals of the vibrator 12 are added, phase-corrected, and then amplified, thereby forming a drive signal. This drive signal is provided to the excitation electrode of the vibrator 12, thereby causing the vibrator 12 to vibrate. In this case, with the vibrator 12 shown in FIG. 2, the vibration member 18 bends and vibrates in the direction perpendicular to the excitation electrode 22. With the vibrator 12 shown in FIG. 3, the vibration member 24 bends and vibrates in the direction perpendicular to the surface on which the piezoelectric element 26c is formed.

In addition, the detecting terminals of the vibrator 12 are connected to a signal processing circuit. The signal processing circuit includes a differential circuit 32, a synchronous detection circuit 34, a smoothing circuit 36, and an amplifying circuit 38. The detecting terminals of the vibrator 12 are connected to input ports of the differential circuit 32, and an output port of the differential circuit 32 is in turn connected to the synchronous detection circuit 34. The synchronous detection circuit 34 synchronizes with a signal from the oscillation circuit 30 through a phase-shift circuit 33 to detect an output signal from the differential circuit 32. The synchronous detection circuit 34 is connected to the smoothing circuit 36, which is in turn connected to the amplifying circuit 38.

In the vibrating gyroscope 10, the oscillation circuit 30 causes excitation of the vibration. For example, in the vibrators 12 shown in FIGS. 2 and 3, bending vibrations are excited. During the vibration, since the two detecting terminals output uniform signals, no signals output from the detecting terminals are output from the differential circuit 32. In this state, when a rotation angular velocity is applied to the vibrator 12, the vibration state of the vibrator 12 changes due to the Coriolis force. Consequently, a difference is generated between the output signals of the two detecting terminals, thereby causing the differential circuit 32 to output a signal. The output signal from the differential circuit 32 is detected by the synchronous detection circuit 34, smoothed by the smoothing circuit 36, and then amplified by the amplifying circuit 38. Since the output signal from the differential circuit 32 corresponds to a change in the vibration state of the vibrator 12, the rotation angular velocity applied to the vibrator 12 can be detected by measuring the signal output from the amplifying circuit 38.

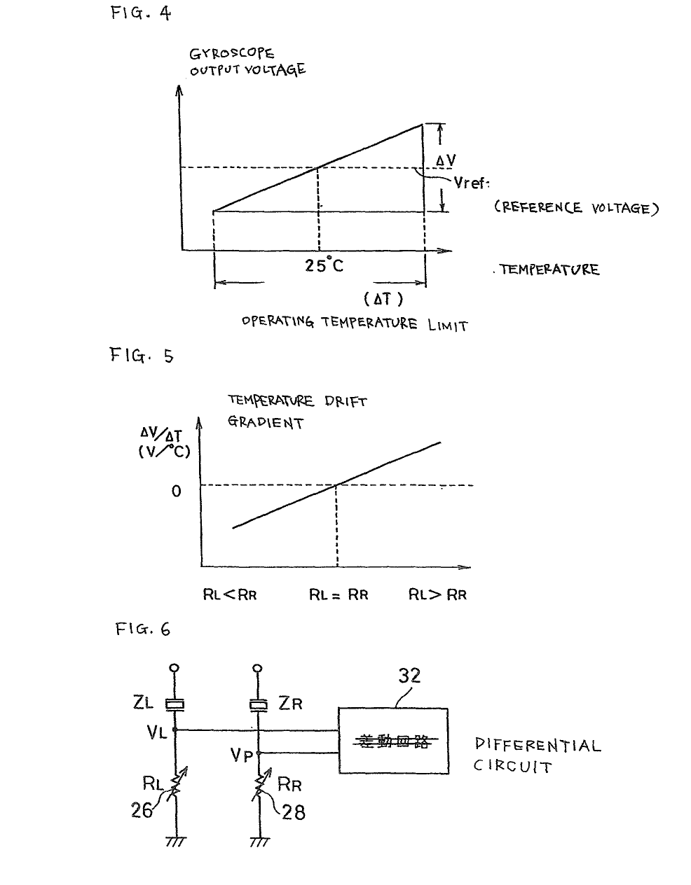

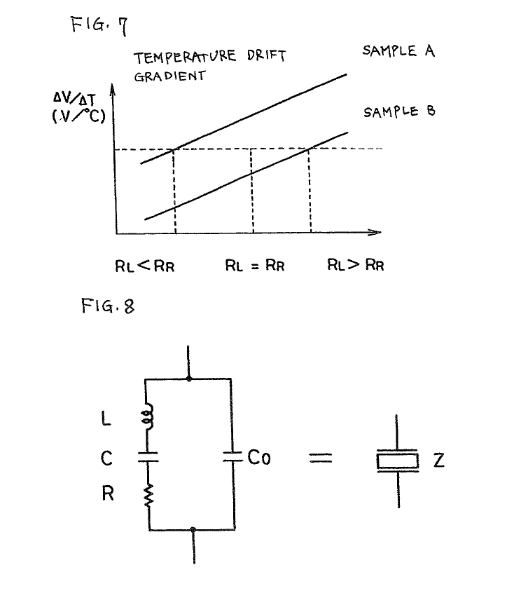

In the vibrating gyroscope 10, the vibrator 12 is formed so as to output a signal that serves as a reference voltage at about 25° C. when not rotating; however, as shown in FIG. 4, the output signals from the vibrator 12 and the signal processing circuit exhibit temperature drift, and thus vary depending upon the ambient temperature. In FIG. 4, a change (ΔV) in voltage output from the signal processing circuit versus the temperature change (ΔT) is the temperature drift gradient (ΔV/ΔT). In the case where the resonance characteristics of the two detecting terminals of the vibrator 12 are the same, and when R_{L}=R_{R}, as shown in FIG. 5, the temperature drift gradient becomes zero, where R_{L} and R_{R} are the resistance values of the load resistances 26 and 28, respectively. On the other hand, as the difference between R_{L} and R_{R} becomes larger, the temperature drift gradient also becomes greater.

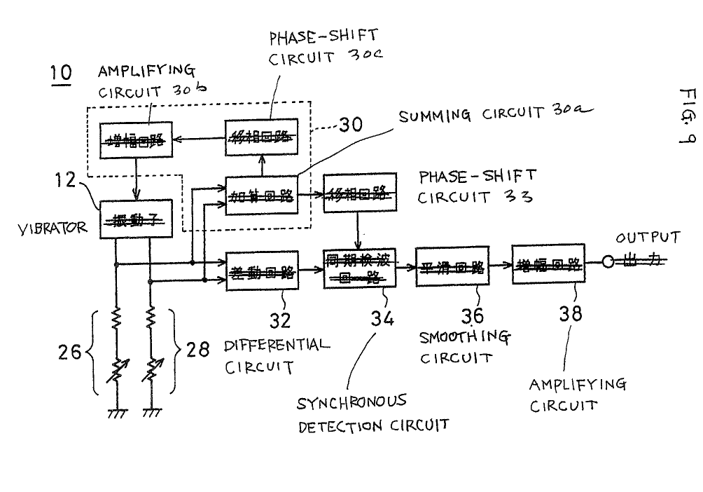

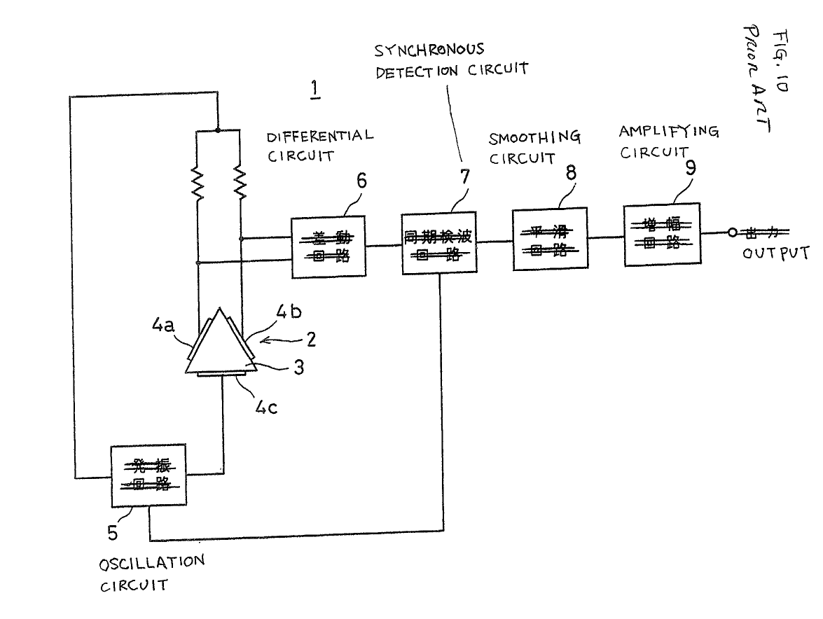

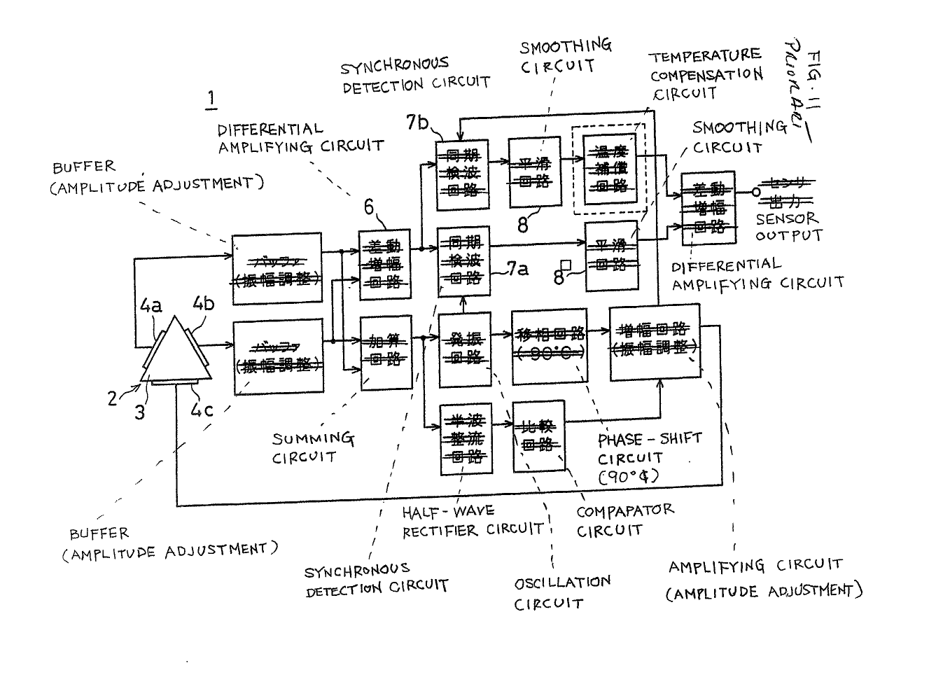

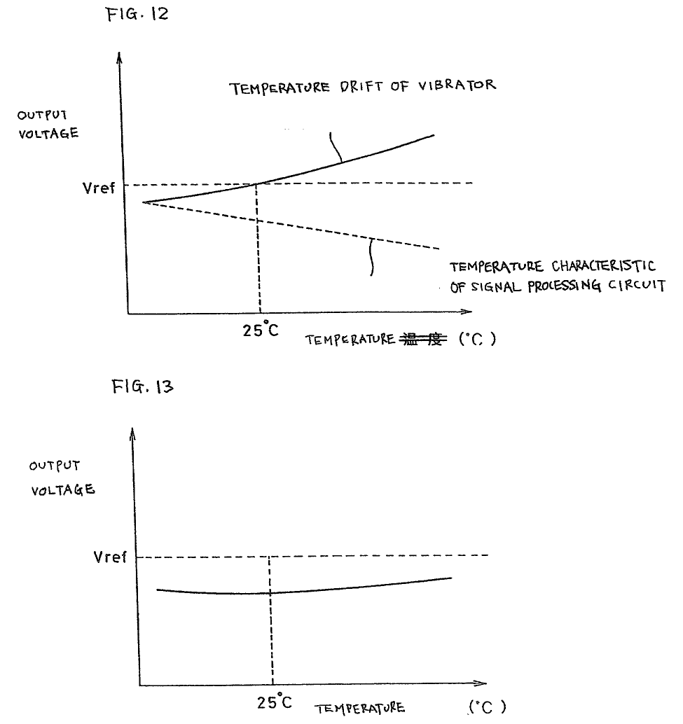

That is, when the resonance characteristic of each of the detecting terminals of the vibrator 12 is substantially the same, as shown in FIG. 6, the impedances Z_{L} and Z_{R} thereof are also substantially equal. In this case, by setting the resistance values R_{L} and R_{R} of the load resistances 26 and 28 to the same value, the amplitudes and phases of the voltages V_{L} and V_{R} output from the two detecting terminals become substantially equal, the voltages V_{L} and V_{R} being determined from the division ratio between Z and R. Even with a change in temperature, the change between them remains the same. In this case, no substantial temperature drift occurs, so that the temperature drift gradient becomes substantially zero.

However, when the impedances of the detecting terminals are shifted such that the relationship therebetween becomes, for example, Z_{L}>Z_{R}, the amplitudes of the detected voltages, which can be determined from the division ratio between Z and R, becomes V_{L} <V_{R}, where the resistance values R_{L} and R_{R} of the load resistances 26 and 28 are equal. In addition, a phase difference is generated, so that the relationship between the load resistance values and the detecting terminal impedances changes. Consequently, when the ambient temperature changes, both the amplitudes and phases of the detected voltages change and become different from the amplitudes and phases of a signal output from the oscillation circuit 30, which results in an output signal having a temperature drift component.

Thus, in the vibrating gyroscope 10, when a difference such as Z_{L >Z}_{R} is generated between the impedances of the detecting terminals, setting the load resistance values to satisfy the relationship R_{L}>R_{R} allows the amplitudes of the detected voltages, which are determined from the division ratio, to be set to substantially V_{L}=V_{R}, and also allows the phases thereof to be set substantially equal. Thus, as shown with a sample A and a sample B in FIG. 7, in the case of Z_{L}>Z_{R}, setting the load resistance values to satisfy the relationship R_{L}>R_{R} allows the temperature drift gradient to be set to zero. In the case of Z_{L}<Z_{R}, setting the load resistance values to satisfy the relationship R_{L}<R_{R} allows the temperature drift gradient to be set to zero.

As shown in FIG. 8, equivalent circuits of the impedances Z_{L} and Z_{R} of the detecting terminals of the vibrator 12 include a resistance, a capacitor, and an inductor, SO that merely changing the load resistance values and matching the amplitudes and phases cannot minimize the temperature drift gradient. The temperature drift gradient can be minimized in such a manner that the temperature drift in the case of RL=R_{R} is measured to determine the temperature drift gradient, and a final adjustment for R_{L} and R_{R} is performed in accordance with an empirical formula. The empirical formula represents the relationship between the temperature drift and the load resistance value shown in FIGS. 5 and 7.

To perform such an adjustment, the resistance values of the load resistances 26 and 28 are adjusted, in which case, trimming resistances or resistors may be used for the variable resistances for use as the load resistances 26 and 28 so that the temperature drift can be adjusted by adjusting the amount of trimming.

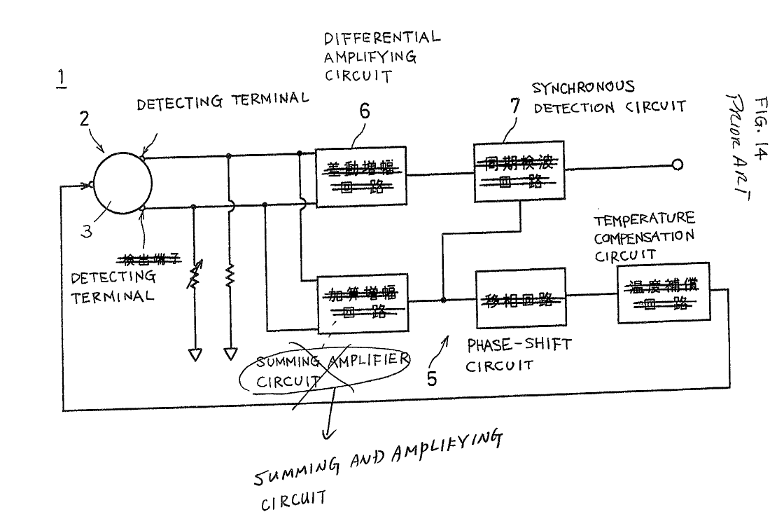

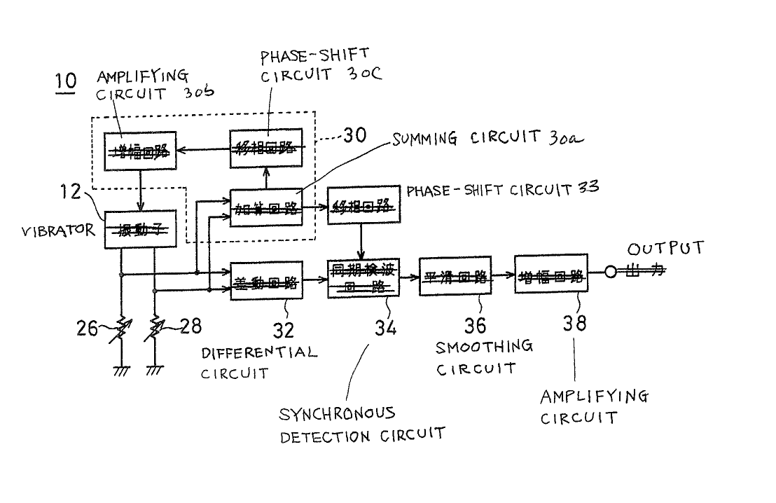

While a method which is disclosed in Japanese Unexamined Patent Application Publication No. 8-189834 is not configured to adjust the temperature drift of a vibrating gyroscope, it discloses a variable resistance connected to one of the detecting terminals of a vibrator to adjust the null voltage. In this vibrating gyro 1, as shown in FIG. 14, one of two detecting terminals formed on the side surfaces of a cylindrical vibration member 3 is connected to ground through a variable resistance, and the other terminal is connected to ground through a fixed resistance.

In the vibrating gyroscope 1 shown in FIG. 14, resistances connected to the detecting terminals of the vibrator 2 are not used as input resistances for the differential amplifying circuit. Thus, even if the null voltage is adjusted by adjusting the variable resistance, the detection sensitivity of the signal processing circuit can be maintained constant. In the vibrating gyroscope 1, however, when the variable resistance is formed of a trimming resistance or the like, the resistance value cannot be increased or decreased, thus allowing the adjustment in one direction only. Thus, the adjustment of the null voltage is also allowed in only one direction. Thus, when variation of the vibrators in the manufacturing process is considered, the adjustment of the null voltage requires that a trimming resistance be formed so as to provide such a resistance value that the null voltage is strongly biased toward one side. Almost all vibrating gyroscopes, therefore, requires adjustment of the trimming resistances.

In contrast, in the vibrating gyroscope 10 of the present invention, the temperature drift is adjusted by adjusting the relationship between the load resistances 26 and 28 connected to the two detecting terminals of the vibrator 12. Thus, as with the sample A and the sample B shown in FIG. 7, the temperature drift can be adjusted in both directions by adjusting either one of the load resistances 26 and 28. Consequently, the temperature drift of the vibrating gyroscope 10 can be suppressed by a simple adjustment, without the need for biasing the resistance values of the load resistances 26 and 28 to a great extent in advance.

In this manner, according to the present invention, the temperature drift of the vibrating gyroscope 10 can be adjusted by a simple adjustment. Thus, as shown in FIG. 9, each of the load resistances 26 and 28 may be formed of a fixed resistance and a variable resistance to achieve fine adjustment. In such a case, even when the variable resistance is adjusted, the resistance values of the load resistances 26 and 28 do not greatly change on the whole, thereby allowing high-accuracy adjustment.

While the vibrating gyroscopes 10 shown in FIGS. 1 and 9 each use the resistances as the load impedances, any elements such as capacitors or inductors which can convert an electric charge generated in the vibrator 12 into a voltage may be used. In addition, the present invention can be applied to any vibrator that generates temperature drift, other than the vibrators 12 having the structures shown in FIGS. 2 and 3.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A temperature-drift adjusting method for a vibrating gyroscope which comprises a vibrator having a detecting terminal for extracting electric charge that is generated due to a Coriolis force; an oscillation circuit for vibrating said vibrator; a load impedance connected to the detecting terminal of said vibrator for converting the electric charge into a voltage; and a signal processing circuit for processing a signal output from the detecting terminal of said vibrator and for outputting a signal corresponding to a rotation angular velocity, said method comprising:
adjusting the impedance value of the load impedance in accordance with a temperature drift gradient indicating a change in a voltage output from said signal processing circuit in response to a change in temperature to minimize the temperature drift gradient.

2. A temperature-drift adjusting method for a vibrating gyroscope which comprises a vibrator having first and second detecting terminals for extracting electric charge that is generated due to a Coriolis force; an oscillation circuit for vibrating said vibrator; first and second load impedances connected respectively to the first and second detecting terminals of said vibrator for converting the electric charge extracted by the first and second electrodes into respective voltages; and a signal processing circuit for processing signal outputs from the first and second detecting terminals of said vibrator and for outputting a signal corresponding to a rotation angular velocity, said method comprising:
adjusting the impedance value of at least one of the first and second load impedances in accordance with a temperature drift gradient indicating a change in a voltage output from said signal processing circuit in response to a change in temperature to minimize the temperature drift gradient.

3. A temperature-drift adjusting method according to claim 2, wherein each of the first and second load impedances includes a variable resistor.

4. A temperature-drift adjusting method according to claim 2, wherein each of the first and second load impedances include a fixed resistor and a variable resistor.

5. A vibrating gyroscope, wherein the temperature drift of the vibrating gyroscope is adjusted by a temperature-drift adjusting method according to claim 1.

6. A vibrating gyroscope, wherein the temperature drift of the vibrating gyroscope is adjusted by a temperature-drift adjusting method according to claim 2.

7. A vibrating gyroscope, wherein the temperature drift of the vibrating gyroscope is adjusted by a temperature-drift adjusting method according to claim 3.

8. A vibrating gyroscope, wherein the temperature drift of the vibrating gyroscope is adjusted by a temperature-drift adjusting method according to claim 4.
